(19) United States
(12) Patent Application Publication
(10) Pub. No.: US 2025/0340004 A1
(43) Pub. Date: Nov. 6, 2025

(54) GENERATIVE ARTIFICIAL INTELLIGENCE BASED MOLD CREATION TO MINIMIZE A REJECTION OF A CASTING PRODUCT DUE TO A DISTORTION

(71) Applicant: International Business Machines Corporation, Armonk, NY (US)

(72) Inventors: Sarbajit K. Rakshit, Kolkata (IN); Sathya Santhar, Ramapuram (IN); Sridevi Kannan, Chennai (IN)

(21) Appl. No.: 18/654,305

(22) Filed: May 3, 2024

(51) Int. Cl. B29C 45/76; B33Y 50/02

(52) U.S. Cl. CPC B29C 45/768; B29C 2945/76949; B33Y 50/02

(57) ABSTRACT

One or more computer processors predicting a distortion in a cast product created from a mold, utilizing a trained generative model. The one or more computer processors modify the mold associated with the predicted distortion. The one or more computer processors generate a corrective mold design for one or more material and shape conditions to remediate the predicted distortion. The one or more computer processors create a corrective mold with an appropriate specification based on the corrective mold design using a robotic system to minimize post-processing. The one or more computer processors produce a final cast product with the created corrective mold.

### BACKGROUND

The invention relates generally to the field of artificial intelligence, and more particularly to mold creation.

Artificial intelligence (AI) refers to the convergent fields of computer and data science focused on building machines to perform tasks that would previously have required a human being. For example, learning, reasoning, problem-solving, perception, language understanding and more. Instead of relying on explicit instructions from a programmer, AI systems can learn from data, allowing them to handle complex problems (as well as simple-but-receptive tasks) and improve over time. AI operates on three fundamental components: data, algorithms, and computing power. (1) Data: AI systems learn and make decisions based on data, and they require large quantities of data to train effectively, especially in the case of machine learning (ML) models. Data is often divided into three categories: training data (helps the model learn), validation data (tunes the model) and test data (assesses the model's performance). For optimal performance, AI models should receive data from a diverse dataset (e.g., text, images, audio, and more), which enable the system to generalize its learning to new, unseen data. (2) Algorithms: Algorithms are the sets of rules AI systems use to process data and make decisions. The category of AI algorithms includes ML algorithms, which learn and make predictions and decisions without explicit programming. AI can also work from deep learning algorithms, a subset of ML that uses multi-layered artificial neural networks (ANNs)—hence the “deep” descriptor—to model high-level abstractions within big data infrastructures. And reinforcement learning algorithms enable the agent to learn behavior by performing functions and receiving punishments and rewards based on their correctness, iteratively adjusting the model until it's fully trained. (3) Computing power: AI algorithms often necessitate significant computing resources to process such large quantities of data and run complex algorithms, especially in the case of deep learning. Many organizations rely on specialized hardware, like graphic processing units (GPUs), to streamline these processes.

Generative AI is a type of AI that generates a plurality of types of content, including text, speech, music, images, video, and code, while interpreting and manipulating pre-existing data. The machine-learning techniques behind generative AI have evolved over the past decade. The latest approach is based on a neural network architecture referred to as a “transformer”. Combining transformer architecture with unsupervised learning, large foundation models emerged that outperform existing benchmarks capable of handling multiple data modalities. Large foundation models serve as the starting point for the development of more advanced and complex models. By building on top of a foundation model, a more specialized and sophisticated model tailored to specific use cases or domains can be created.

Generative adversarial network (GAN) is an approach to generative modeling using a deep learning method, such as a convolutional neural network. Generative modeling is an unsupervised learning task in machine learning that involves automatically discovering and learning a regularity or a pattern in input data in such a way that a model can be used to generate and output new examples that plausibly could have been drawn from the original dataset.

Conditional GAN (cGAN) guide the data creation process by incorporating specific parameters or labels into the GAN. Both adversarial networks—the generator and the discriminator—consider these parameters when producing outputs. With this input, the generator creates faux data that imitates real data and adheres to the set condition and just like in the regular GAN model, the discriminator will distinguish between the forged data produced by the generator and the genuine data corresponding to the given condition. With the conditional aspect included, cGANs can produce exact and highly specific data for tasks that require bespoke results. This control over the kind of data generated allows businesses to cater to their unique needs, making cGANs versatile tools in data creation and augmentation.

### SUMMARY

Embodiments of the invention disclose a computer-implemented method, a computer program product, and a system. The computer-implemented method includes one or more computer processers predicting a distortion in a cast product created from a mold, utilizing a trained generative model. The one or more computer processors modify the mold associated with the predicted distortion. The one or more computer processors generate a corrective mold design for one or more material and shape conditions to remediate the predicted distortion. The one or more computer processors create a corrective mold with an appropriate specification based on the corrective mold design using a robotic system to minimize post-processing. The one or more computer processors produce a final cast product with the created corrective mold.

### BRIEF DESCRIPTION OF THE DRAWINGS

FIG. 1 is a functional block diagram illustrating a distributed data processing environment, in accordance with an embodiment of the invention;

FIG. 2 is a flowchart illustrating the operational steps of a generative artificial intelligence based mold creation program, on a server within the distributed data processing environment of FIG. 1, in accordance with an embodiment of the invention;

FIG. 3A is an illustration of exemplary distortions in a casting process, in accordance with an embodiment of the invention;

FIG. 3B is an illustration of casting deformations, in accordance with an embodiment of the invention;

FIG. 3C is an illustration of an exemplary mold and cast industrial process, in accordance with an embodiment of the invention;

FIG. 3D is an illustration of parameters that affect the exemplary mold and cast industrial process, in accordance with an embodiment of the invention;

FIG. 3E is an illustration of industrial parameters, in accordance with an embodiment of the invention;

FIG. 3F is an illustration of predicted distortions with corresponding corrective mold/casts, in accordance with an embodiment of the invention;

FIG. 3G is an illustration of an exemplary generative adversarial network, in accordance with an embodiment of the invention;

FIG. 3H is an illustration of an exemplary mold/cast simulation, in accordance with an embodiment of the invention;

FIG. 3I is an illustration of an exemplary corrective molding with a casted work product, in accordance with an embodiment of the invention;

FIG. 3J is an illustration of a monitored industrial environment, in accordance with an embodiment of the invention;

FIG. 3K is an illustration of an exemplary deep neural network, in accordance with an embodiment of the invention;

FIG. 3L is an illustration of a controlled industrial automation process, in accordance with an embodiment of the invention; and

FIG. 4 depicts a block diagram of components of a computing environment representing the distributed data processing environment of FIG. 1, in accordance with an embodiment of the invention.

### DETAILED DESCRIPTION

Embodiments of the invention recognize that, during the casting process, the quality of the castings is influenced by several factors. If the distortion exceeds a certain threshold limit, the cast object may be rejected, defective, or inferior. However, if the distortion is within the acceptable range, it can be corrected through post-production techniques such as machining, metal cutting, heat treatment, and bending. It is also important to consider mold adaptation and determine the appropriate allowance (e.g., deviations made in the dimensions of a pattern from final desired dimensions of a finished product to be kept on the mold) ensuring that one or more deformations in the cast product (e.g., work product) can be effectively corrected during post-processing.

Embodiments of the invention recognize that, in the mold and cast industry, several factors can lead to distortions in the output of the final products. These distortions can occur during the molding and casting processes and result in products that do not meet the desired specifications. To minimize the distortions in the mold and cast industry, it is essential to consider the factors contributing to the distortion during the design and manufacturing processes. Proper mold design, material selection, cooling strategies, and careful monitoring of the production process can help reduce the occurrence of distortions and ensure that the final products meet the desired specifications. While the manual intervention proves to be time consuming and not as effective as the expectations, it is important to take advantage of the AI models and automate the process, thereby the distortions in the output are minimized and the wastage is reduced.

Embodiments of the invention recognize that the reason for a distortion in the metal casting includes, but is not limited to, a thermal gradient, a shrinkage, a residual stress, a mold constraint, a core shift, an inadequate support or anchoring, and a machining operation. In regard to the thermal gradients, during the casting process, the molten metal undergoes cooling and solidification, resulting in thermal gradients within the casting. Non-uniform cooling rates can cause differential contraction and expansion, leading to distortion. In regard to the shrinkage, as the molten metal cools and solidifies, it undergoes shrinkage. Varied shrinkage rates across different sections of the casting can cause distortion. This is particularly significant in complex-shaped castings or sections with fluctuating wall thicknesses. In regard to the residual stress, the residual stress can develop during solidification and cooling due to non-uniform thermal contraction or volumetric changes. The residual stress can cause the casting to distort, especially if they are not properly relieved or balanced. In regard to the mold constraints, the design and characteristics of the mold used for casting also contribute to distortion. Inadequate mold rigidity or improper gating and riser systems can result in non-uniform cooling and uneven distribution of metal during solidification, leading to distortion. In regard to the core shift, if the core used to create internal cavities in the casting shifts during the pouring or solidification process, it can cause uneven cooling and result in distortion. In regard to the inadequate support or anchoring, improper support or anchoring mechanisms during cooling and solidification can allow the casting to deform under its own weight or due to internal stresses. In regard to the machining operations, distortion can also occur during subsequent machining operations, such as cutting or grinding, if the casting is not properly supported or if excessive material is removed in certain areas.

Embodiments of the invention recognize that after the casting process, several post-production steps are performed on the casting product to achieve the desired final result. These steps may vary depending on the specific requirements of the casting and its intended application. The common post-production steps in casting include, but are not limited to, a removal of gating and risers, a surface cleaning and finishing, a machining and precision operation, a heat treatment, a surface coating and/or plating, a non-destructive testing (NDT), an assembly and integration, a quality inspection and testing, and a surface protection. In regard to the removal of gating and risers, the gating and risers, which are used to facilitate the flow of molten metal into the casting and compensate for shrinkage, are typically removed. This can be done through cutting, grinding, or other machining processes. In regard to the surface cleaning and finishing, the casting surface may undergo cleaning processes to remove any residual sand, scale, or oxides. Finishing techniques like grinding, sanding, or polishing may be employed to achieve the desired surface texture and appearance. In regard to the machining and precision operations, depending on the casting's design and requirements, additional machining operations may be performed to achieve precise dimensions, tight tolerances, and smooth surfaces. This can include processes such as milling, drilling, turning, and tapping. In regard to the heat treatment, the heat treatment processes like annealing, quenching, or tempering may be applied to enhance the mechanical properties of the casting, such as hardness, strength, or ductility. Heat treatment can also relieve residual stresses and improve dimensional stability. In regard to the surface coating or plating, to provide additional protection or enhance casting appearance, surface coatings or plating like painting, powder coating, electroplating, or galvanizing may be applied. In regard to the non-destructive testing (NDT), the various NDT methods like visual inspection, dye penetrant testing, ultrasonic testing, or X-ray inspection may be employed to detect any internal or surface defects, ensuring casting integrity and quality. In regard to an assembly and integration, if the casting is part of a larger assembly or requires integration with other components, additional steps such as welding, brazing, or fastening may be performed to join the casting with other parts. In regard to the quality inspection and testing, comprehensive quality inspections, including dimensional checks, hardness testing, mechanical property testing, and functional testing, are conducted to verify that the casting meets the specified requirements and standards. In regard to surface protection, finally, the casting may undergo surface protection measures such as corrosion prevention coatings, sealing, or painting to enhance its durability and longevity.

Embodiments of the invention recognize that a plurality of parameters control the quality of the casting process and significantly impact the integrity, dimensional accuracy, surface finish, and mechanical properties of the final cast product. Some key parameters that influence the quality of the casting process include, but are not limited to, a melting and metal quality; a mold design and material; a pouring and solidification factor; a cooling and solidification rate; a mold and core quality; a process control and monitoring; a post-processing step and heat treatment; and an inspection and quality control factor. In regard to the melting and metal quality, the quality of the metal used for casting, including composition, cleanliness, and temperature control during melting, is critical. Proper melting practices and ensuring the use of high-quality metal with the correct alloy composition are vital to achieve desired casting properties. In regard to the mold design and material, the design of the mold, including the gating system, risers, and venting, directly affects the flow of molten metal and the solidification process. Proper mold design, choice of mold material (such as sand, investment, or permanent mold), and dimensional accuracy of the mold are crucial for achieving quality castings. In regard to the pouring and solidification factor, the pouring temperature, rate, and technique during metal transfer into the mold play a crucial role in controlling the solidification process. Proper control of these parameters ensures even filling, reduced defects (like shrinkage or porosity), and proper solidification of the casting. In regard to the cooling and solidification rate, the cooling rate during solidification impacts the microstructure and mechanical properties of the casting. Proper control of cooling rates through mold design, insulation, and cooling media can help prevent issues like cracks or distortion and promote desired microstructural characteristics. In regard to the mold and core quality, the quality and condition of the mold and cores used in the casting process are critical. Factors like mold surface finish, dimensional accuracy, and core strength and stability can affect the final casting's surface finish, dimensional accuracy, and overall integrity. In regard to the process control and monitoring, maintaining process parameters within defined tolerances is essential for consistent casting quality. Parameters like pouring temperature, mold temperature, solidification time, and cooling rates need to be closely monitored and controlled to ensure repeatability and adherence to quality standards. In regard to post-processing and heat treatment, proper post-processing steps, including cleaning, machining, heat treatment, and surface finishing, are crucial to achieve the desired final product quality. These steps remove defects, improve dimensional accuracy, enhance mechanical properties, and achieve the required surface finish. In regard to inspection and quality control, the regular inspection and quality control measures, including non-destructive testing (NDT), dimensional checks, visual inspections, and mechanical property testing, are vital to identify and address any defects or deviations from specifications. By carefully controlling these parameters and implementing appropriate process controls, casting manufacturers can optimize the quality of their castings, ensuring they meet the required specifications and performance standards. Embodiments of the invention recognize that these post-production steps ensure that the casting product meets the desired specifications, functional requirements, and aesthetic considerations before it is ready for use or further integration into larger systems or structures.

Embodiments of the invention recognize a need for a system and method to use the deep neural network and the generative AI models to predict the output distortion type based on the various factors and parameters of the mold and cast industry and generate the corresponding corrective mold using the generative AI model. The generated corrective mold is physically produced by industry and stored for subsequent identified or predicted distorted output. The timeline of the distorted output is predicted by the deep neural network based on the real time industry data and parameters.

Embodiments of the invention provide a system and method to consider a historical visual analysis of distorted work products manufactured with casting, a capability and a limit of different correction methods, an amount of material removal during post-processing process, and a specification of the molding material. Embodiments of the invention provide a system and method to create a generative AI model that will correlate with a final product, a distorted product and a shape of a mold, and accordingly to identify an amount of allowance be kept on the mold so that distortion of the work product manufactured with casting process can be minimized with minimal post-processing.

Embodiments of the invention provide a system and method to receive the 3D model design of the work product to be manufactured with casting based on the material specification, molding specification, temperature used, etc. Embodiments of the invention provide a system and method to use generative AI model to identify a number of changes to be applied to the shape of the mold, such that once the work product deforms during casting process, then the same number can be removed with appropriate post-processing steps, reducing casting product errors and remediation costs, and accordingly utilizing a 3D GAN to generate modified mold structure.

Embodiments of the invention provide a system and method to consider a need of different types of required post-processing on the casting work product, such as a level of surface finishing etc., to identify the amount of deformation that may happen on a different portion of the work product. Accordingly, embodiments of the invention provide a system and method use generative AI model (e.g., 3D GAN) to modify the shape of the mold so that an optimal post-processing is to be performed.

Embodiments of the invention provide a system and method to consider various influencing factors that contribute to deformation of the work product, and accordingly the generative AI model will be used for identifying optimum allowance on the mold, so that with minimum excess material formation on the work product and with minimum machining, the deformed work product can be converted to high quality work product with post-processing.

Based on the dynamic design of the mold using a generative AI model and 3D GAN, embodiments of the invention provide a system and method to use a robotic system to create the mold with appropriate specifications, so that with minimum post-processing, the distorted work product can be converted to a required quality work product.

Implementation of embodiments of the invention may take a variety of forms, and exemplary implementation details are discussed subsequently with reference to the Figures.

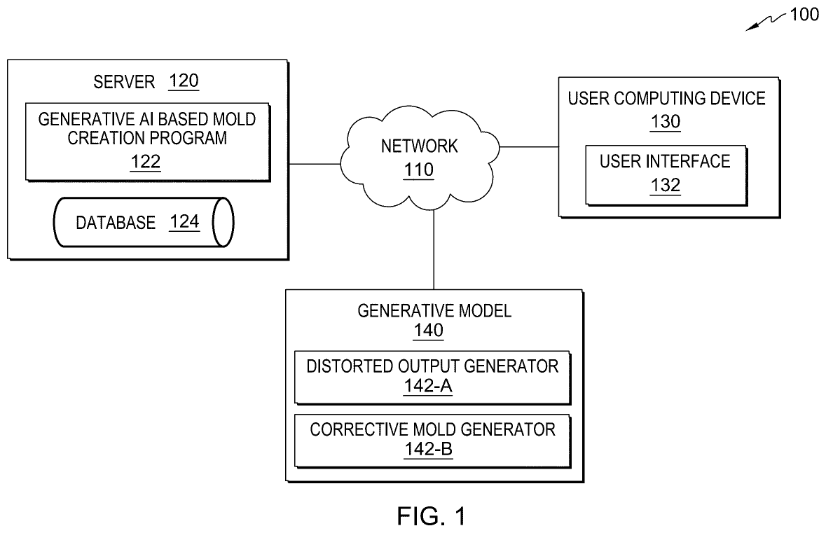

FIG. 1 is a block diagram illustrating a distributed data processing environment, generally designated 100, in accordance with an embodiment of the invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

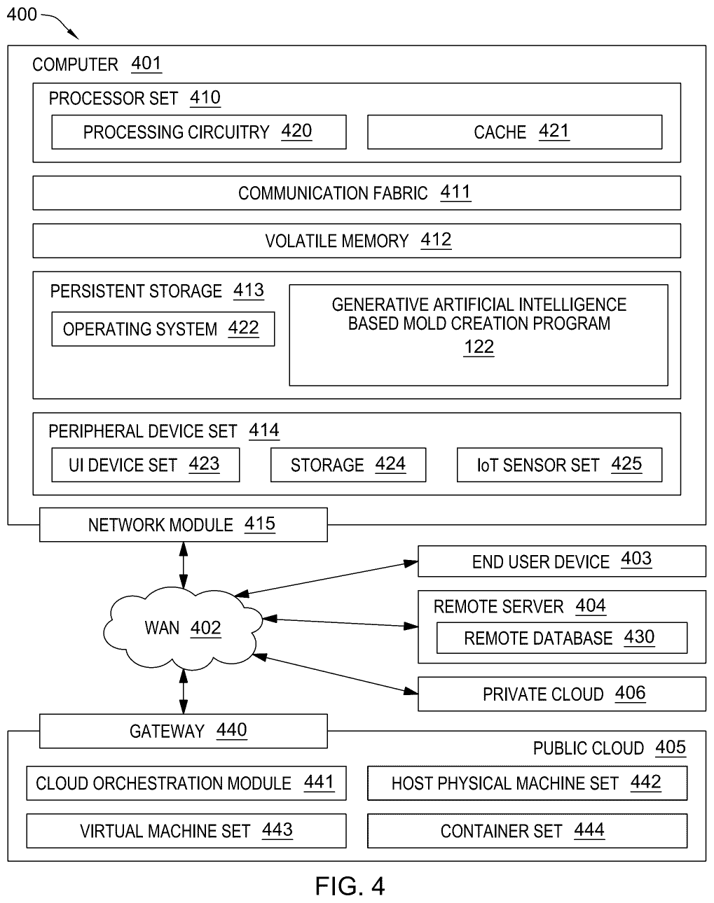

Server 120 operates to run generative artificial intelligence-based mold creation program 122 and to send and/or store data in database 124. In an embodiment, server 120 can send data from database 124 to user computing device 130. In an embodiment, server 120 can receive data in database 124 from user computing device 130. In an embodiment, server 120 includes generative artificial intelligence-based mold creation program 122 and database 124. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 4.

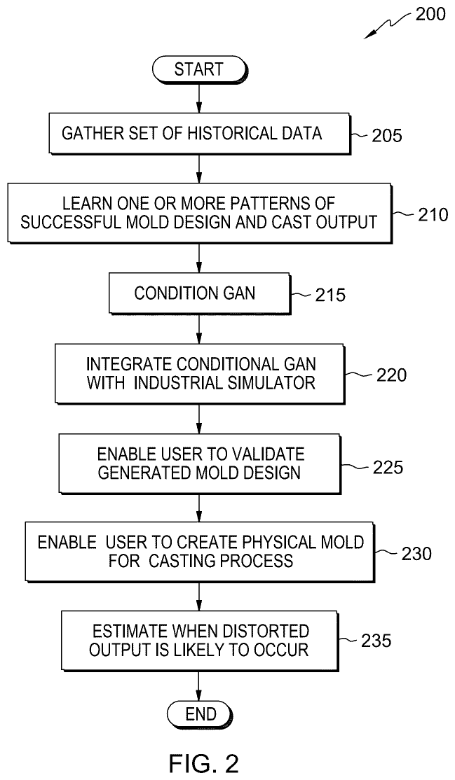

Generative artificial intelligence-based mold creation program 122 operates to create and modify casting molds responsive to predicted casting distortions. In various embodiments, generative artificial intelligence-based mold creation program 122 may implement the following steps: predict a distortion in a cast product created from a mold, utilizing a trained generative model; modify the mold associated with the predicted distortion; generate a corrective mold design for one or more material and shape conditions to remediate the predicted distortion; create a corrective mold with an appropriate specification based on the corrective mold design using a robotic system to minimize post-processing; and produce a final cast product with the created corrective mold. In the depicted embodiment, generative artificial intelligence-based mold creation program 122 is a standalone program. In another embodiment, generative artificial intelligence-based mold creation program 122 may be integrated into another software product. The operational steps of generative artificial intelligence-based mold creation program 122 are depicted and described in further detail with respect to FIG. 2.

In an embodiment, a user of a user computing device (e.g., user computing device 130) registers with generative artificial intelligence-based mold creation program 122 of server 120. For example, the user completes a registration process (e.g., user validation), provides information to create a user profile, and authorizes the collection, analysis, and distribution (i.e., opts-in) of relevant data on an identified computing device (e.g., user computing device 130) by server 120 (e.g., via generative artificial intelligence-based mold creation program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by generative artificial intelligence-based mold creation program 122. A database is an organized collection of data. Data includes, but is not limited to, information about user preferences (e.g., general user system settings such as alert notifications for a user computing device (e.g., user computing device 130)); information about alert notification preferences; historical parameters; historical distortions; historical molds; and/or generated by generative artificial intelligence-based mold creation program 122. Database 124 can be implemented with any type of device capable of storing data and configuration files that can be accessed and utilized by server 120, such as a hard disk drive, a database server, or a flash memory. In an embodiment, database 124 is accessed by generative artificial intelligence-based mold creation program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that generative artificial intelligence-based mold creation program 122 has access to database 124.

The invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Generative artificial intelligence-based mold creation program 122 enables the authorized and secure processing of personal data and/or confidential company data.

Generative artificial intelligence-based mold creation program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Generative artificial intelligence-based mold creation program 122 provides information regarding personal and/or confidential company data and the nature (e.g., type, scope, purpose, duration, etc.) of the processing. Generative artificial intelligence-based mold creation program 122 provides the user with copies of stored personal and/or confidential company data. Generative artificial intelligence-based mold creation program 122 allows the correction or completion of incorrect or incomplete personal and/or confidential company data. Generative artificial intelligence-based mold creation program 122 allows for the immediate deletion of personal and/or confidential company data.

User computing device 130 operate to run user interface 132 through which a user can interact with contextual conversational user assistance program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with generative artificial intelligence-based mold creation program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 include an instance of user interface 132.

User interface 132 operates as a local user interface between contextual conversational user assistance program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from generative artificial intelligence-based mold creation program 122 to a user via network 110. User interface 132 can also display or present alerts including information (such as graphics, text, and/or sound) sent from generative artificial intelligence-based mold creation program 122 to a user via network 110. In an embodiment, user interface 132 can send and receive data (i.e., to and from generative artificial intelligence-based mold creation program 122 via network 110, respectively). Through user interface 132, a user can opt-in to generative artificial intelligence-based mold creation program 122; input information; create a user profile; set user preferences and alert notification preferences; receive a request for feedback; and input feedback.

A user preference is a setting that can be customized for a particular user. A set of default user preferences are assigned to each user of contextual conversational user assistance program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of generative artificial intelligence-based mold creation program 122.

FIG. 2 is a flowchart, generally designated 200, illustrating the operational steps for generative artificial intelligence-based mold creation program 122, on server 120 within distributed data processing environment 100 of FIG. 1, in accordance with an embodiment of the invention. In an embodiment, generative artificial intelligence-based mold creation program 122 operates to create and modify casting molds responsive to predicted casting distortions. It should be appreciated that the process depicted in FIG. 2 illustrates one possible iteration of the process flow, which may be repeated in a polling fashion (e.g., once a single active session or once over a plurality of active sessions) or in an on-demand fashion (e.g., whenever a user requests).

In step 205, generative artificial intelligence-based mold creation program 122 gathers a set of historical data. In an embodiment, generative artificial intelligence-based mold creation program 122 gathers a set of historical data from a production database (e.g., database 124). The set of historical data includes, but is not limited to, data regarding mold specifications and data regarding casting parameters (e.g., material properties, mold design, cooling rate, process parameters, mold temperature (C), pouring temperature (° C.), cooling temperature (° C.), and injection velocity (m/s)). In an embodiment, generative artificial intelligence-based mold creation program 122 transmits the set of historical data to a generative model (e.g., generative model 140). In an embodiment, generative artificial intelligence-based mold creation program 122 monitors for real-time data from an associated industrial casting system or a robotic casting system under the control of generative artificial intelligence-based mold creation program 122.

In step 210, the generative model (e.g., generative model 140) learns one or more patterns of a successful mold design and cast output. In an embodiment, the generative model (e.g., generative model 140) learns one or more patterns of a successful mold design and cast output by leveraging the set of historical data gathered. In an embodiment, generative artificial intelligence-based mold creation program 122 trains generative model 140 with historical molds, distortions, mold designs, and corrective measures/techniques. In an embodiment, the generative model (e.g., generative model 140) is a type of generative adversarial network that is conditioned (i.e., a conditional GAN or cGAN) on additional information, such as a type of material required and a shape of a mold and a cast. In an embodiment, the conditional GAN receives the parameters from the mold and cast industry database and the type of material required (e.g., metal, plastic, etc.) along with the shape of the mold and the cast as additional input. In an embodiment, generative artificial intelligence-based mold creation program 122 correlates historical distortions with one or more corrective castings that results in an optimal work product.

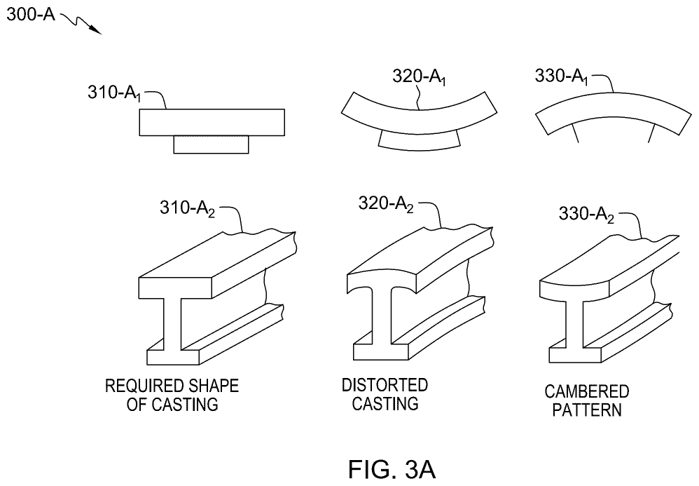

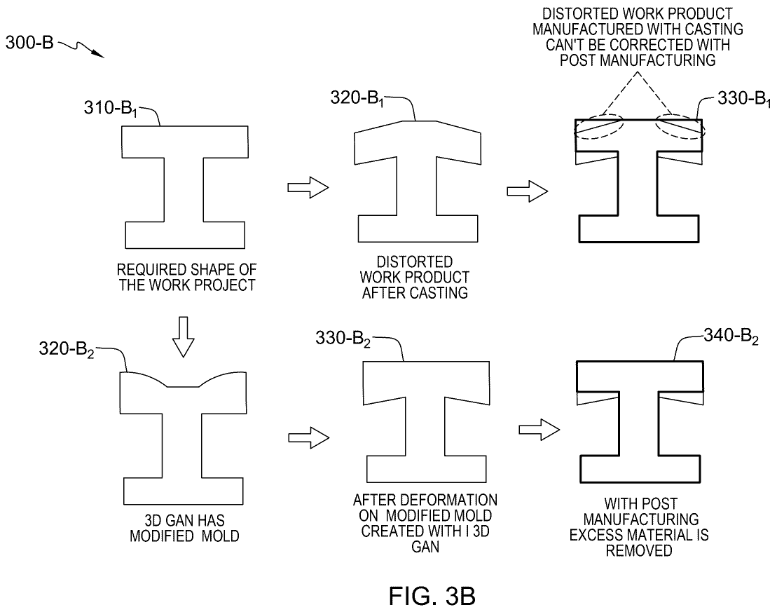

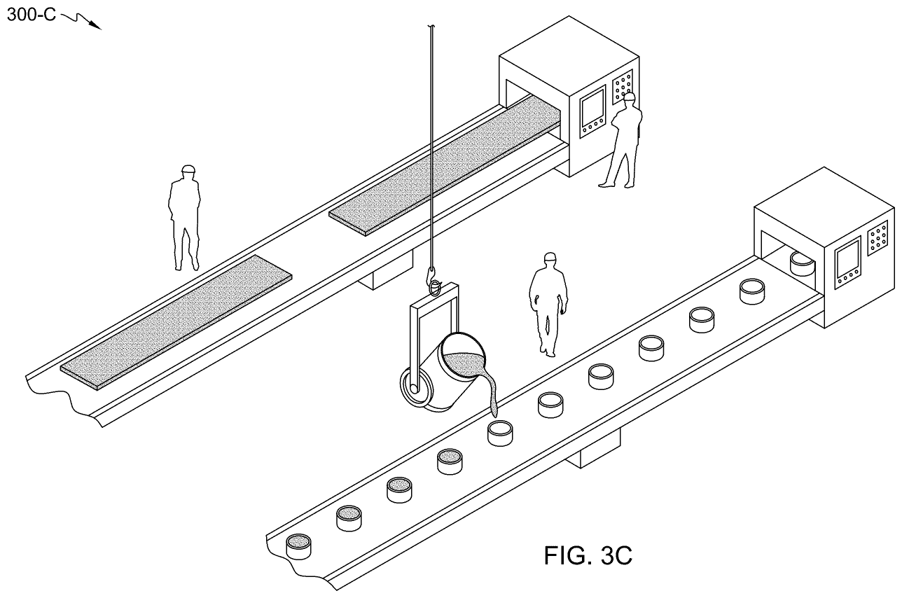

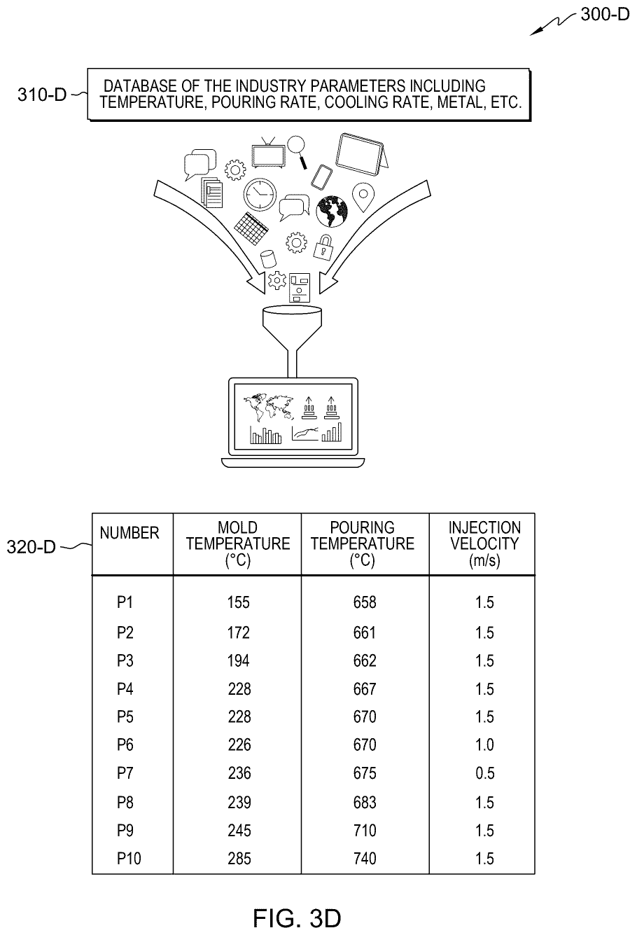

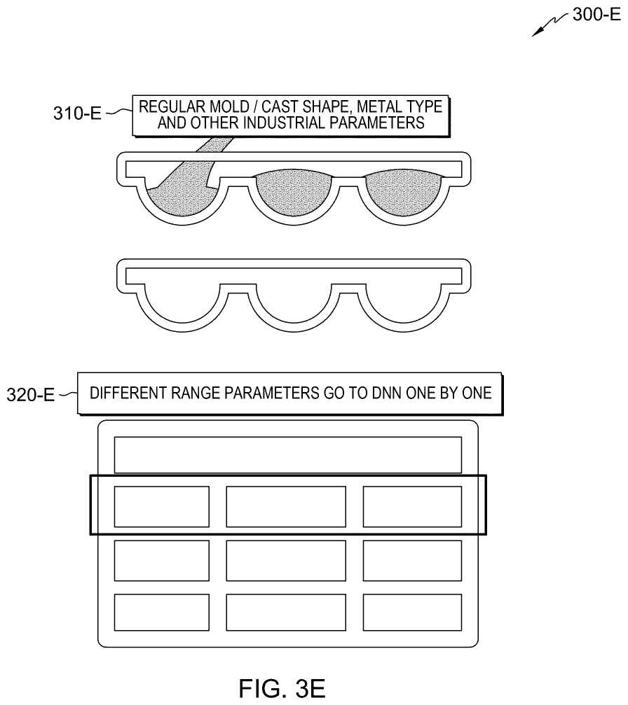

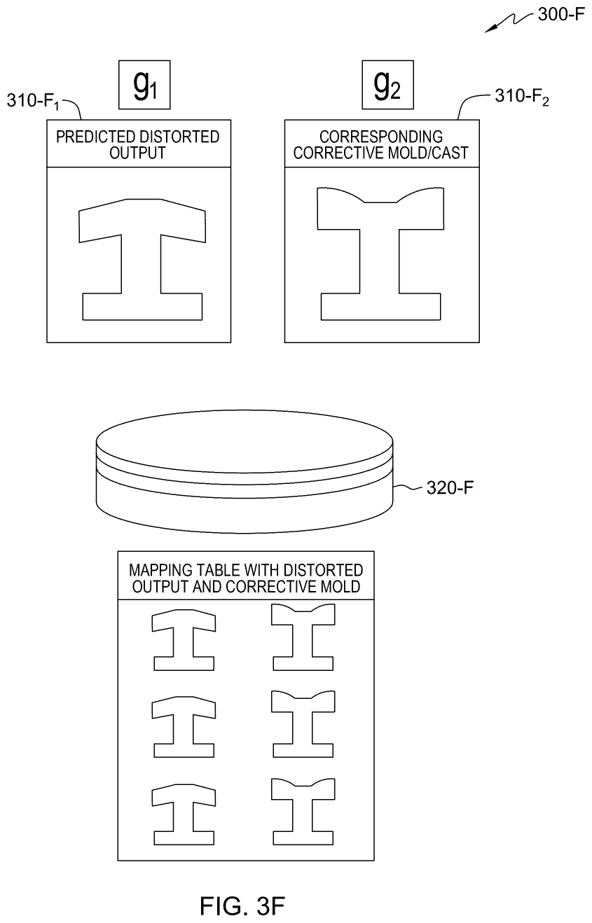

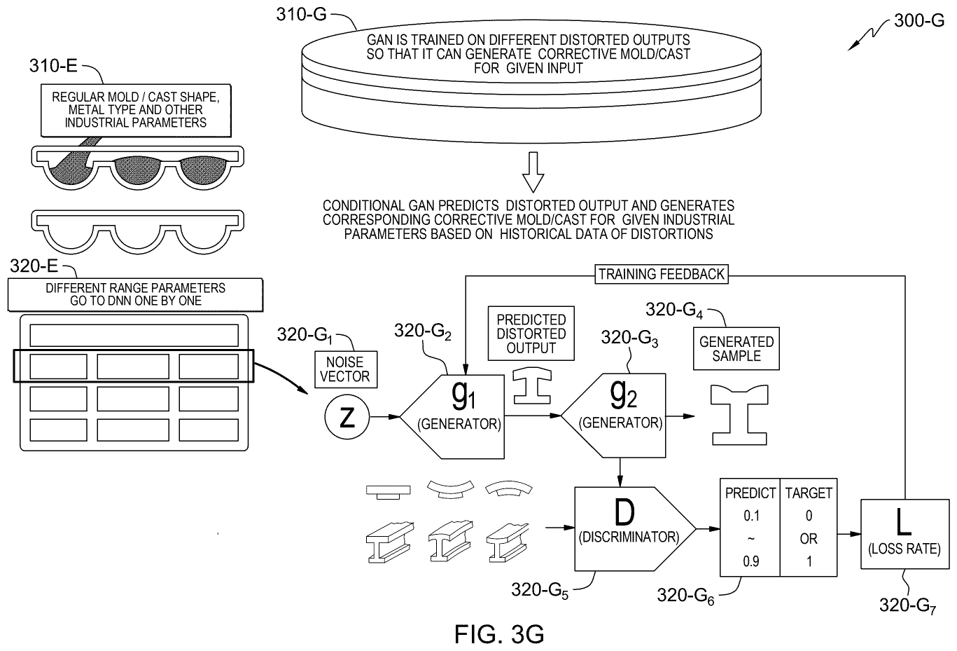

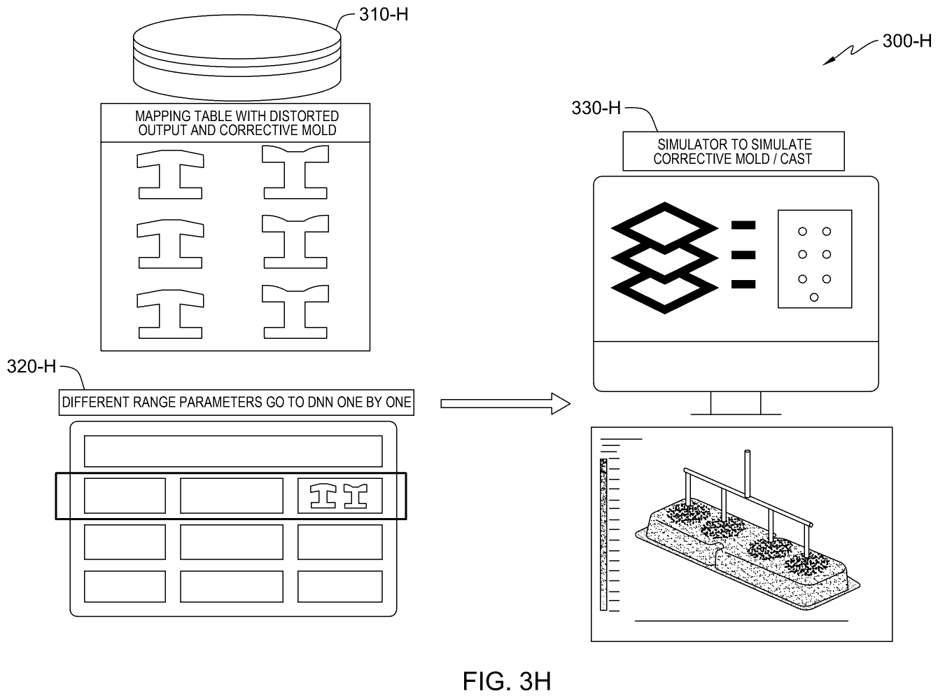

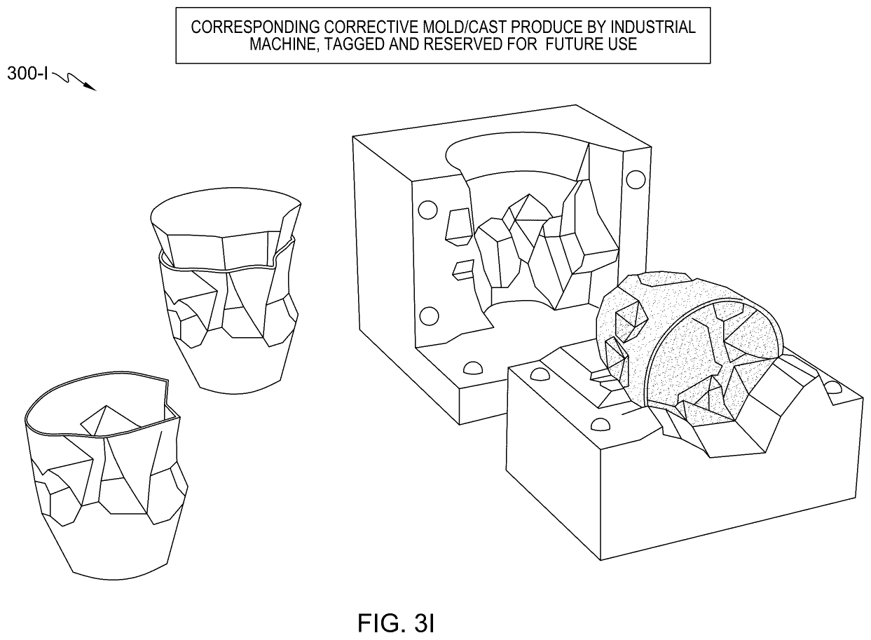

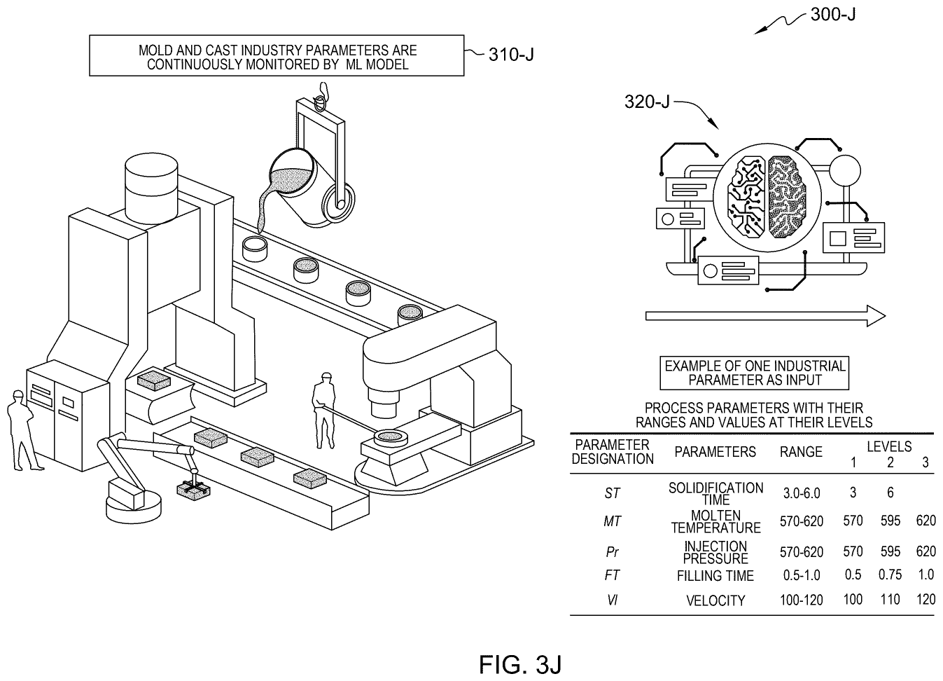

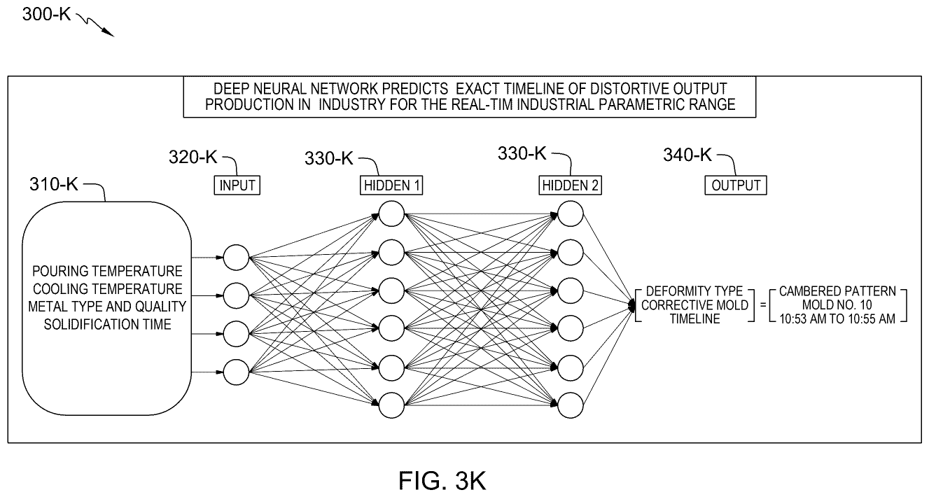

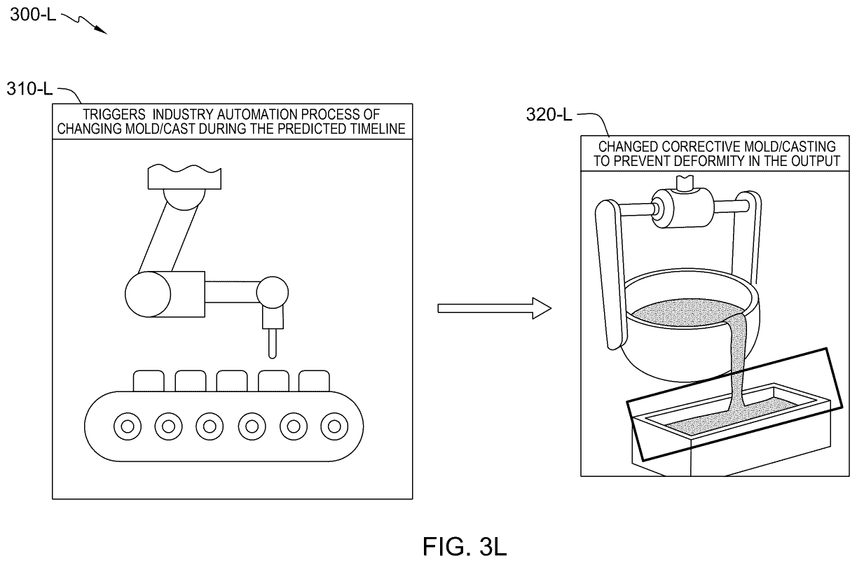

In an embodiment, the generative model (e.g., generative model 140) (also referred to as cGAN) contains two generators, as depicted in FIGS. 3F and 3G. The two generators include a distorted output generator (e.g., distorted output generator 142-A) and a corrective mold generator (e.g., corrective mold generator 142-B). In an embodiment, the distorted output generator (e.g., distorted output generator 142-A) uses the combined input data to produce a prediction of the potential distortions in the final cast product, considering the influence of the material type and mold shape and other parameters. In an embodiment, the corrective mold generator (corrective mold generator 142-B) is conditioned on the same inputs and generates a corrective mold design that accounts for the specific material and shape conditions to counteract the predicted distortions effectively. In an embodiment, the generated outputs of the distorted output generator (e.g., distorted output generator 142-A) and the corrective mold generator (e.g., corrective mold generator 142-B) are mapped against one another. In an embodiment, the generated outputs of the distorted output generator (e.g., distorted output generator 142-A) and the corrective mold generator (e.g., corrective mold generator 142-B) are stored in a database when the discriminator no longer can distinguish the real and the generated outputs. In an embodiment, the generative model (e.g., generative model 140) produces a new design proposal. In another embodiment, the generative model (e.g., generative model 140) simulates a potential outcome. In another embodiment, the generative model (e.g., generative model 140) enhances an overall manufacturing process efficiency rating.

In step 215, generative artificial intelligence-based mold creation program 122 conditions the GAN (e.g., FIG. 3K). In an embodiment, a discriminator of the generative model (e.g., generative model 140) (cGAN) evaluates the generated outputs of the distorted output generator (e.g., distorted output generator 142-A) and the corrective mold generator (e.g., corrective mold generator 142-B). In an embodiment, the discriminator of the generative model (e.g., generative model 140) (cGAN) considers the conditional information when evaluating the generated outputs of the distorted output generator (e.g., distorted output generator 142-A) and the corrective mold generator (e.g., corrective mold generator 142-B). In an embodiment, the discriminator of the generative model (e.g., generative model 140) (cGAN) evaluates the generated outputs of the distorted output generator (e.g., distorted output generator 142-A) and the corrective mold generator (e.g., corrective mold generator 142-B) to provide feedback to improve the training process.

In an embodiment, generative artificial intelligence-based mold creation program 122 conditions the GAN on a type of material and a mold and cast shape. In an embodiment, generative artificial intelligence-based mold creation program 122 conditions the GAN to make the cGAN more specialized in predicting and correcting distortions for one or more materials and one or more shapes. In an embodiment, generative artificial intelligence-based mold creation program 122 conditions the GAN to obtain a more accurate and tailored corrective mold design and an improved overall manufacturing outcome.

In step 220, generative artificial intelligence-based mold creation program 122 integrates the conditional GAN with an industrial simulator. An industrial simulator may be, but is not limited to, a Computer-Aided Design (CAD) software. In an embodiment, responsive to the training and optimization of the conditional GAN using the mold and cast industry database (e.g., FIG. 3H), generative artificial intelligence-based mold creation program 122 integrates the conditional GAN with an industrial simulator. In an embodiment, generative artificial intelligence-based mold creation program 122 integrates the conditional GAN with the industrial simulator to enable the GAN to communicate with the CAD system to generate and visualize the corrective mold designs directly. In an embodiment, responsive to the GAN generating the corrective mold design based on the given material type, the mold and cast shape, and other input parameters, generative artificial intelligence-based mold creation program 122 outputs the corrective mold design to the CAD system. In an embodiment, the CAD system receives the corrective mold design. In an embodiment, the CAD system converts the virtual mold design into a tangible and manufacturable mold (e.g., FIG. 3I).

In step 225, generative artificial intelligence-based mold creation program 122 enables a user to validate the generated mold design. In an embodiment, responsive to the user determining the generated mold design needs to be adjusted, generative artificial intelligence-based mold creation program 122 enables the user to refine the generated mold design. In an embodiment, generative artificial intelligence-based mold creation program 122 enables the user to refine (i.e., to modify and reprocess) the generated mold design iteratively to optimize the generated mold design (i.e., to meet one or more manufacturing standards and/or one or more requirements). The user may include, but is not limited to, an engineer and an expert in the mold and cast industry. In an embodiment, generative artificial intelligence-based mold creation program 122 adjusts one or more graphical elements associated with a graphical user interface (GUI). For example, generative artificial intelligence-based mold creation program 122 adjusts elements that correspond to one or more modifications made to a mold design to compensate for one or more predicted distortions.

In step 230, generative artificial intelligence-based mold creation program 122 enables the user to create a physical mold for the casting process. In an embodiment, responsive to approving the generated mold design, generative artificial intelligence-based mold creation program 122 enables the user to create a physical mold for the casting process. The physical mold is created using one or more techniques. The one or more techniques may include, but are not limited to, CNC machining and three-dimension (3D) printing. The one or more techniques used depends on a manufacturing capability of the industry. In an embodiment, generative artificial intelligence-based mold creation program 122 instructs a robotic industrial system to construct the generated mold and initiate a casting process with the generated mold.

In step 235, generative artificial intelligence-based mold creation program 122 predicts when the distorted output is likely to occur. In an embodiment, generative artificial intelligence-based mold creation program 122 estimates when the distorted output is likely to occur based on one or more real-time parameters associated with the industrial unit. In an embodiment, generative artificial intelligence-based mold creation program 122 estimates when the distorted output is likely to occur using a Deep Neural Network (DNN). The predictive capability allows for proactive measures to be taken to update the corrective mold automatically during the specific period of time of the production process. In an embodiment, generative artificial intelligence-based mold creation program 122 estimates when a distorted output is likely to occur. In an embodiment, generative artificial intelligence-based mold creation program 122 estimates when a distorted output is likely to occur by employing a Deep Neural Network (DNN) as a predictive model. In an embodiment, the DNN receives as an input one or more process parameters. The one or more process parameters includes, but is not limited to, a type of material, a shape of a mold and/or a cast, a temperature, a cooling rate, and other variables relevant to the process. In an embodiment, the DNN analyzes the historical data and any patterns relevant to the historical data obtained from the conditional GAN's outputs. In an embodiment, the DNN analyzes the historical data and any patterns relevant to the historical data to learn a relationship between an input parameter and an occurrence of a distortion in the final cast product. By combining the capabilities of the conditional GAN with the predictive power of the DNN, the proposed model creates an intelligent and proactive system that continuously improves the manufacturing process, enhances product quality, and reduces production costs through automated and data-driven decision-making.

In an embodiment, generative artificial intelligence-based mold creation program 122 continuously monitors the process parameters. In an embodiment, generative artificial intelligence-based mold creation program 122 continuously runs the process parameters through the DNN. In an embodiment, generative artificial intelligence-based mold creation program 122 outputs a real-time prediction of when a distortion is likely to happen. The real-time prediction serves as an early warning system, to generate a corresponding corrective mold using the conditional GAN, updating the industry belt, and applying the corrective mold. The real-time prediction indicates when to intervene before a distortion is likely to happen (i.e., during a specific time window). This ensures that the corrective mold design is always up-to-date and tailored to the current conditions, optimizing the production process, and minimizing the occurrence of defects. The conditional GAN accurately predicts potential distortions and generates corresponding corrective molds based on material type and mold shape. The industrial simulator enables visualization and validation of corrective mold designs, ensuring manufacturability. The DNN predicts the optimal time for mold updates, enabling proactive adjustments during production.

FIG. 3A depicts 300-A, illustrating a plurality of exemplary distortions in a casting process. 300-A includes 310-A1, 310-A2, 320-A1, 320-A2, 330-A1, and 330-A2. 310-A2 depicts a required shape of an exemplary cast and 310-A1 is a cross-section view of 310-A2. 320-A2 depicts a distorted shape of an exemplary cast and 320-A1 is a cross-section view of 320-A2. 330-A2 depicts a cambered shape of an exemplary cast and 330-A1 is a cross-section view of 330-A2.

FIG. 3B depicts 300-B which illustrates a plurality of casting deformations and corresponding modified molds and castings. In 300-B, the invention identifies an optimum allowance that can be kept on the mold, so that even after deformation, with minimum machining, a high-quality work product can be manufactured. 300-B includes 310-B1, 320-B1, 320-B2, 330-B1, 330-B2, and 340-B2. 310-B1 depicts a required shape of an exemplary cast. 320-B1 depicts a work product that was distorted after a casting process. 330-B1 depicts one or more corrections that are needed to verify the distorted work product in 320-B1. 320-B2 depicts a mold modified by embodiments of the invention, wherein the mold is utilized to create a work product illustrated in 330-B2. 340-B2 is a resulting work product after post manufacturing removes excess material from 320-B2.

FIG. 3C depicts 300-C which illustrates an exemplary mold and cast industrial process, where distortions may arise in casts due to parameters, resulting in an inability to achieve a desired work product (e.g., cast).

FIG. 3D depicts 300-D which illustrates a plurality of parameters that affect the exemplary mold and cast industrial process as described in 300-C. 300-D includes 310-D, a database comprises the parameters (e.g., temperature, pouring rate, cooling rate, metal), and 320-D, a table containing values corresponding to the parameters.

FIG. 3E depicts 300-E which illustrates a plurality of industrial parameters (i.e., 310-E) such as mold/cast shape and metal parameters. 300-E also includes 320-E which depicts a range of parameters, depicted in 310-E, that will be inputted into a model (e.g., generative AI model).

FIG. 3F depicts 300-F which illustrates predicted distortions with corresponding corrective mold/casts. 300-F includes 310-F1, 310-F2, and 320-F. 310-F1 is a predicted distorted work product and 310-F2 is a corrective mold/cast generated by embodiments of the invention responsive to 310-F1. 320-F is a table that maps predicted distortions (i.e., 310-F1) with corrective molds (i.e., 310-F2).

FIG. 3G depicts 300-G which illustrates an exemplary GAN model (i.e., 310-G) (e.g., generative model 140) that inputs 310-E (i.e., 310-F1) and 320-E (i.e., 310-F2) into noise vector (i.e., 320-G1) which is responsively inputted into a generator (i.e., 320-G2). 320-G2 generates a predicted distorted which is inputted into another generator (i.e., 320-G3), generating 320-G4, a generated corrective mold. Embodiments of the invention then input 320-G4 into a discriminator (320-G5) which outputs 320-G6, a final output (i.e., corrective mold that results in a desired work product based on predicted distortions). Finally, embodiments of the invention utilize 320-G6 to calculate a loss rate (i.e., 320-G7) which is utilized as training feedback for the GAN model.

FIG. 3H depicts 300-H which illustrates an exemplary mold/cast simulation (i.e., 330-H) based on 310-H, mapping table with distorted output and corrective mold, and 320-H, a generated corrective mold/cast for a parameter; resulting in 330-H (i.e., corrective mold/cast simulation).

FIG. 3I depicts 300-I which illustrates an exemplary corrective molding with a casted work product, where the mold/cast is produced by an industrial machine, tagged, and reserved for the future use.

FIG. 3J depicts 300-J which illustrates a monitored industrial environment. 300-J includes 310-J, a molding and casting industrial process where one or more parameters (e.g., solidification time, molten temperature, injection pressure, filling time, and velocity) are continuously monitored and inputted into 320-J, an exemplary ML model.

FIG. 3K depicts 300-K which illustrates an exemplary deep neural network (DNN) that is utilized by embodiments of the invention to predict a timeline of distortive output production for a real-time industrial parametric range. 300-K includes 310-K, a plurality of parameters (e.g., pouring temperature, cooling temperature, metal type and quality, solidification time), 320-K, a parameterized input, 330-K, a plurality of hidden layers associated with the DNN, and 340-K, a DNN output (e.g., identified distortion, simulated defect, corrective mold).

FIG. 3L depicts 300-L which illustrates one or more embodiments of the invention controlling an industrial automation process (i.e., 310-L) of changing a mold/cast during a predicted timeline, in which embodiments of the invention change a mold (i.e., 320-L) and/or cast to prevent predicted deformities in a resulting work product.

FIG. 4 depicts a block diagram of components of server 120 within distributed data processing environment 100 of FIG. 1, in accordance with an embodiment of the invention. It should be appreciated that FIG. 4 provides only an illustration of one implementation and does not imply any limitations with regard to the environments in which different embodiments can be implemented. Many modifications to the depicted environment can be made.

Computing environment 400 contains an example of an environment for the execution of at least some of the computer code involved in performing the inventive methods, such as generative artificial intelligence-based mold creation program 122. In addition to generative artificial intelligence-based mold creation program 122, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and generative artificial intelligence-based mold creation program 122, as identified above), peripheral device set 414 (including user interface (UI), device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

Computer 401, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip”. In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in generative artificial intelligence-based mold creation program 122 in persistent storage 413.

Communication fabric 411 is the signal conduction paths that allow the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, the volatile memory is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid-state storage devices. Operating system 422 may take several forms, such as various known proprietary operating systems or open-source Portable Operating System Interface type operating systems that employ a kernel. The code included in generative artificial intelligence-based mold creation program 122 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The foregoing descriptions of the various embodiments of the invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
predicting, by one or more computer processors, a distortion in a cast product created from a mold, utilizing a trained generative model;
modifying, by one or more computer processors, the mold associated with the predicted distortion, further comprising:
generating, by one or more computer processors, a corrective mold design for one or more material and shape conditions to remediate the predicted distortion; and
creating, by one or more computer processors, a corrective mold with an appropriate specification based on the corrective mold design using a robotic system to minimize post-processing; and
producing, by one or more computer processors, a final cast product with the created corrective mold.

2. The computer-implemented method of claim 1, wherein training the generative model comprises:
gathering a set of historical data, wherein the set of historical data includes a visual analysis of distorted cast products manufactured with a casting process, one or more capabilities of one or more corrective methods, one or more limits of one or more corrective methods, an amount of material removed during a post-processing process, and a shape of the mold; and
training the generative model with the set of historical data.

3. The computer-implemented method of claim 1, wherein modifying the mold associated with the predicted distortion, further comprises:
receiving a three-dimensional (3D) design of the cast product to be manufactured with casting; and
identifying an amount of allowance on the corrective mold so that the predicted distortion is minimized with minimal post-processing.

4. The computer-implemented method of claim 1, further comprising:
monitoring at least one process parameter selected from the group consisting of a type of material, a shape of a mold, a temperature, and a cooling rate.

5. The computer-implemented method of claim 1, wherein the generative model is a conditional generative adversarial network.

6. The computer-implemented method of claim 1, wherein distortions are selected from the group consisting of a thermal gradient, a shrinkage, a residual stress, a mold constraint, a core shift, an inadequate support or anchoring, and a machining operation.

7. The computer-implemented method of claim 1, wherein post-production steps are selected from the group consisting of a removal of gating and risers, a surface cleaning and finishing, a machining and precision operation, a heat treatment, a surface coating, a non-destructive testing, and a quality inspection.

8. A computer program product comprising:
one or more computer readable storage media having computer-readable program instructions stored on the one or more computer readable storage media, said program instructions executes a computer-implemented method comprising steps of:
predicting a distortion in a cast product created from a mold, utilizing a trained generative model;
modifying the mold associated with the predicted distortion, further comprising:
generating a corrective mold design for one or more material and shape conditions to remediate the predicted distortion; and
creating a corrective mold with an appropriate specification based on the corrective mold design using a robotic system to minimize post-processing; and
producing a final cast product with the created corrective mold.

9. The computer program product of claim 8, wherein the program instructions to train the generative model, stored on the one or more computer readable storage media, comprise the steps of:
gathering a set of historical data, wherein the set of historical data includes a visual analysis of distorted cast products manufactured with a casting process, one or more capabilities of one or more corrective methods, one or more limits of one or more corrective methods, an amount of material removed during a post-processing process, and a shape of the mold; and
training the generative model with the set of historical data.

10. The computer program product of claim 8, wherein the program instructions to modify the mold associated with the predicted distortion, stored on the one or more computer readable storage media, comprise the steps of:
receiving a three-dimensional (3D) design of the cast product to be manufactured with casting; and
identifying an amount of allowance on the corrective mold so that the predicted distortion is minimized with minimal post-processing.

11. The computer program product of claim 8, wherein the program instructions, stored on the one or more computer readable storage media, further comprise the steps of:
monitoring at least one process parameter selected from the group consisting of a type of material, a shape of a mold, a temperature, and a cooling rate.

12. The computer program product of claim 8, wherein the generative model is a conditional generative adversarial network.

13. The computer program product of claim 8, wherein distortions are selected from the group consisting of a thermal gradient, a shrinkage, a residual stress, a mold constraint, a core shift, an inadequate support or anchoring, and a machining operation.

14. The computer program product of claim 8, wherein post-production steps are selected from the group consisting of a removal of gating and risers, a surface cleaning and finishing, a machining and precision operation, a heat treatment, a surface coating, a non-destructive testing, and a quality inspection.

15. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
predicting a distortion in a cast product created from a mold, utilizing a trained generative model;
modifying the mold associated with the predicted distortion, further comprising:
generating a corrective mold design for one or more material and shape conditions to remediate the predicted distortion; and
creating a corrective mold with an appropriate specification based on the corrective mold design using a robotic system to minimize post-processing; and
producing a final cast product with the created corrective mold.

16. The computer system of claim 15, wherein the program instructions to train the generative model, stored on the one or more computer readable storage media, comprise the steps of:
gathering a set of historical data, wherein the set of historical data includes a visual analysis of distorted cast products manufactured with a casting process, one or more capabilities of one or more corrective methods, one or more limits of one or more corrective methods, an amount of material removed during a post-processing process, and a shape of the mold; and
training the generative model with the set of historical data.

17. The computer system of claim 15, wherein the program instructions to modify the mold associated with the predicted distortion, stored on the one or more computer readable storage media, comprise the steps of:
receiving a three-dimensional (3D) design of the cast product to be manufactured with casting; and
identifying an amount of allowance on the corrective mold so that the predicted distortion is minimized with minimal post-processing.

18. The computer system of claim 15, wherein the program instructions, stored on the one or more computer readable storage media, further comprise the steps of:
monitoring at least one process parameter selected from the group consisting of a type of material, a shape of a mold, a temperature, and a cooling rate.

19. The computer system of claim 15, wherein the generative model is a conditional generative adversarial network.

20. The computer system of claim 15, wherein distortions are selected from the group consisting of a thermal gradient, a shrinkage, a residual stress, a mold constraint, a core shift, an inadequate support or anchoring, and a machining operation.
